(19) United States
(12) Patent Application Publication
(10) Pub. No.: US 2015/0324506 A1
(43) Pub. Date: Nov. 12, 2015

(54) ANALOG BEHAVIOR MODELING WITHIN EVENT-DRIVEN DIGITAL SIMULATOR

(71) Applicant: QUALCOMM Incorporated, San Diego, CA (US)

(72) Inventor: Xiang Li, San Diego, CA (US)

(73) Assignee: QUALCOMM Incorporated, San Diego, CA (US)

(21) Appl. No.: 14/274,624

(22) Filed: May 9, 2014

(51) Int. Cl. G06F 17/50

(52) U.S. Cl. CPC G06F 17/5036

(57) ABSTRACT

A method for converting signals within a digital simulation environment is provided. A first analog signal is obtained via a first analog port of a conversion module within a digital simulation environment executed by a processing circuit, wherein the conversion module is configurable to bi-directionally convert between digital signals and analog signals. The first analog signal may be converted into a first digital signal within the digital simulation environment. The first digital signal may then be transmitted over a first digital port.

### BACKGROUND

1. Field

Various features relate to simulating analog behavior within a simulator, and more specifically to a method and/or technique to simulate real number traffic within an event-driven digital simulator.

2. Background

It is common for electronic circuits to be designed and tested using Hardware Description Languages (HDLs). HDLs are computer programming languages that are designed to be particularly suited for giving formal descriptions of electronic circuits. An HDL program can be written that corresponds to, and/or models, a circuit, passive and/or active element(s) of a circuit, and/or interface(s), interconnects, and/or wires/paths of a circuit. When an HDL program is executed, the execution simulates the operation of the circuit, element, path described, thus allowing the characteristics and/or behavior of the circuit to be studied.

A hardware description language (HDL) can be used to model digital and analog mixed-signal systems. In one example, Verilog is commonly used and has been defined by the Institute of Electrical and Electronic Engineers (IEEE) as the IEEE 1364 standard. Verilog is commonly used in the design and verification of digital circuits at the register-transfer level of abstraction. Verilog provides an event-driven digital simulation environment (Verilog digital) and also an analog and/or mixed-signal simulation environment (Verilog-AMS). However, certain weaknesses exist in the standard, particularly with the handling of real number traffic in an event-driven digital simulation environment.

There are many examples of HDLs. Particular HDLs are usually designed primarily for describing either analog circuits (such as Verilog-AMS and VHDL-AMS, and also SPICE, though this is technically a simulator rather than an HDL) or digital circuits (such as Verilog, AHDL, JHDL). Analog HDLs have the advantage that there is much more freedom in the types of circuits that can be described.

However, a disadvantage of analog HDLs (such as Verilog-AMS) is that their execution of programs is commonly considerably slower than that of digital HDLs (such as Verilog or Verilog digital). Another technique is to use an analog HDL to model the analog part of a circuit, and a digital HDL to model the digital part, with the two HDLs passing results between each other as they execute their respective programs. This is known as a mixed-mode HDL. However, the speed of operation of the analog HDL will often still create a bottleneck for the speed of the overall simulation.

Therefore, a method is needed to simulate real number traffic, as in RF/analog/mixed-signal, within an event-driven digital simulator.

### SUMMARY

A method for converting signals within a digital simulation environment is provided. A first analog signal may be obtained via a first analog port of a conversion module within a digital simulation environment executed by a processing circuit, wherein the conversion module is configurable to bi-directionally convert between digital signals and analog signals. In one example, the analog signal may be a real number. The first analog signal may be converted into a first digital signal within the digital simulation environment. The first digital signal may be transmitted over a first digital port. Conversion of the first analog signal into the first digital signal may be performed solely in native hardware description language instructions within the digital simulation environment.

The conversion module may be configurable to operate in a first mode of operation in which it converts an analog signal to a digital signal and operate in a second mode of operation in which it converts a digital signal to an analog signal.

In one example, the first digital signal may be transmitted over a first subset of timeslots, available on the first digital port, allocated to the first digital signal. A second subset of timeslots on the first digital port may be defined for transmissions of a second digital signal while the first subset of timeslots may be concurrently used to transmit the first digital signal. The first subset of timeslots may be utilized for the outgoing first digital signal and the second subset of timeslots may be used for an incoming second digital signal.

A second analog signal may be obtained from a second analog port of the conversion module. The second analog signal may be converted into a second digital signal. A second subset of timeslots, available on the first digital port, may be allocated to the second digital signal. The second digital signal may be transmitted over the first digital port.

The first digital port may be further defined by a second subset of timeslots for a second digital signal, and a third subset of timeslots for a third digital signal. The first digital signal may correspond to a voltage signal, the second digital signal corresponds to a current signal, and the third digital signal corresponds to a frequency signal. The first digital signal, the second digital signal, and the third digital signal may be multiple components and/or characteristics of the first analog signal.

In one example, the first digital port and first analog port of the conversion module may be dynamically configurable as input or output ports. In another example, the first digital port of the conversion module may be dynamically configurable to allocate timeslots to different digital signals.

The first digital port of the conversion module may be dynamically configurable to allocate timeslots for input or output signals, where the designation of a timeslot for input signals is independent of the designation of other timeslots for either input or output signals.

### BRIEF DESCRIPTION OF DRAWINGS

FIG. 1 is a block diagram illustrating an exemplary digital simulation environment in which one or more modules are configured to convert between digital signals (e.g., digital values) and analog signals (e.g., real values).

FIG. 2 is a block diagram illustrating another exemplary analog/mix signal module A defined within a digital simulation environment in which configurable bidirectional modules may be configured to convert multiple analog signals (real values) to digital signals.

FIG. 3 is a block diagram illustrating another exemplary analog/mix signal module B defined within a digital simulation environment in which configurable bidirectional modules may be configured to convert multiple digital signals to analog signals (real values).

FIG. 4 is a block diagram illustrating another exemplary digital simulation environment in which a plurality of modules may be configured to convert between digital signals and analog signals (real values).

FIG. 5 is a block diagram illustrating another exemplary digital simulation environment in which a plurality of modules may be configured to convert between digital signals and analog signals (real values).

FIG. 6 is a block diagram illustrating an exemplary wire for real connect module that is configurable and bidirectional and converts between digital signals and analog (real) signals within a digital simulation environment.

FIG. 7 is a block diagram illustrating an exemplary implementation of the analog-to-digital module in FIG. 6.

FIG. 8 is a block diagram illustrating an exemplary implementation of the digital-to-analog module in FIG. 6.

FIG. 9 is a block diagram illustrating various time division multiplexing schemes that may be used by a configurable, bidirectional wire for real connect module.

FIG. 10 is a block diagram illustrating a device that implements a digital simulator in which one or more aspects for converting and transferring analog/real signals through digital ports may be implemented.

FIG. 11 is a block diagram illustrating a method that may be performed to implement a bidirectional digital-analog conversion module within a digital simulator.

FIG. 12 (comprising FIGS. 12A-12S) illustrates exemplary code/instructions for a digital-analog conversion module in a hardware description language.

### DETAILED DESCRIPTION

In the following description, specific details are given to provide a thorough understanding of the various aspects of the disclosure. However, it will be understood by one of ordinary skill in the art that the aspects may be practiced without these specific details. For example, circuits may be shown in block diagrams in order to avoid obscuring the aspects in unnecessary detail. In other instances, well-known circuits, structures, and techniques may not be shown in detail in order not to obscure the aspects of the disclosure.

The word “exemplary” is used herein to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation.

### Overview

A first aspect provides a conversion module that transfers analog signal values (e.g., real values) through a digital connection (or port) within a digital simulator executed by a processing circuit, where the digital connection is also a representation of a physical analog connection (or port). This conversion may be done, for example, only with code native to the digital simulator (e.g., without external calls or non-native instructions to the digital simulator).

A second aspect provides for the conversion module including one or more analog ports and at least one digital port, where the digital port may use time division multiplexing to carry a plurality of analog signals values in different timeslots.

A third aspect provides for the conversion module including a plurality of bi-directional input/output channels over a single digital port, such that some of the timeslots over the digital port may be associated with a first input signal while other timeslots may be associated with a second output signal.

A fourth aspect provides for the conversion module to dynamically configure its input and output ports while the digital simulator is running.

### Exemplary Simulation Environment

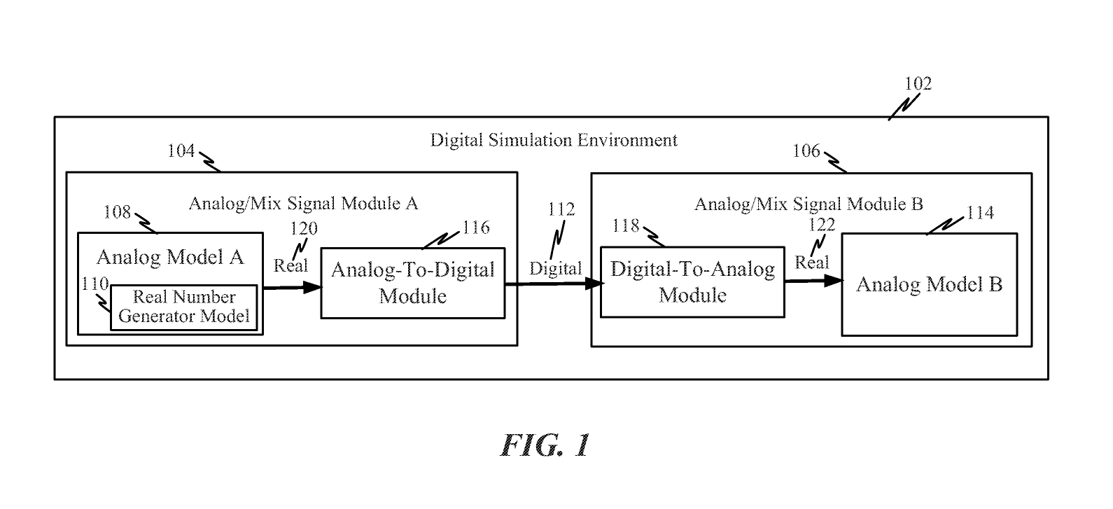

FIG. 1 is a block diagram illustrating an exemplary digital simulation environment in which one or more modules are configured to convert between analog signals (e.g., real values) and digital signals (e.g., digital values). The digital simulation environment 102 may implement a hardware description language (HDL) that may be used to model digital signal systems. In one example, the digital simulation environment 102 may be a Verilog environment. The digital simulation environment 102 may define one or more analog and/or mix-signal modules 104 and 106. An analog module may simulate analog circuit or components and a mixed-signal module may simulate circuits having both digital and analog components. In some implementations, the analog/mix signal modules 104 and 106 may include an analog model A 108 and an analog model B 114. In one example, the digital simulation environment 102 may define the analog model A 108 and/or analog model B 114 to simulate electrical circuits, components (e.g., memory, drivers, programmable-logic arrays, amplifiers, etc.), elements (e.g., capacitors, resistors, inductors, etc.), and/or electrical paths (e.g., interconnects, conductive routes, vias, etc.). The analog model A 108 may include a Real Number Generator Model 110 that generates real numbers as outputs which are used by the analog model A 108 to generate an analog signal 120. An analog-to-digital module 116 converts and/or encapsulates the analog signal(s) 120 (e.g., real values) output by the analog model A 108 into a digital signal 112 (e.g., sequence or stream of bits). The analog/mix signal module A 104 may then transmit the digital 112 (with the embedded analog signal) to the analog/mix signal module B 106. A digital-to-analog module 118 may receive and convert the digital signal 112 into an analog signal 122 that serves as an input to the analog model B 114.

Note that both the analog-to-digital module 116 and the digital-to-analog module 118 may be implemented with native hardware description language within the digital simulation environment (e.g., without external components or external modules).

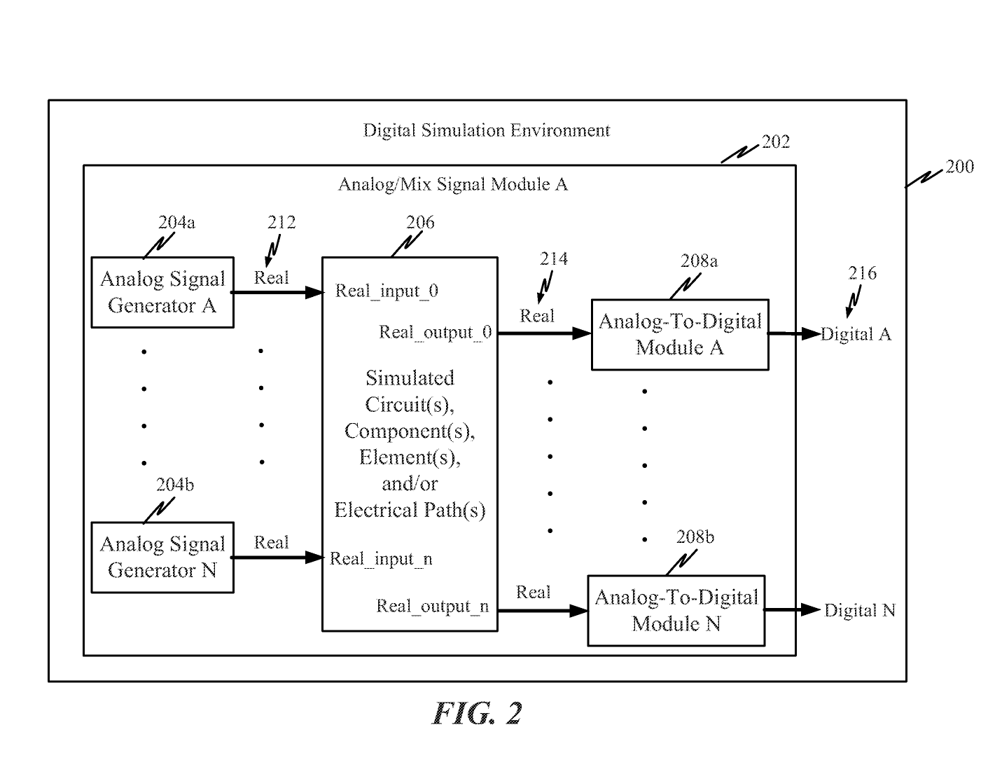

FIG. 2 is a block diagram illustrating another exemplary analog/mix signal module A 202 defined within a digital simulation environment 200 in which configurable bidirectional modules may be configured to convert multiple analog signals (real values) 214 to digital signals 216. In this example, a plurality of analog signal generators 204a, 204b may be used to generate analog signals (real values) 212 which may serve as inputs to a simulated circuit(s), component(s), element(s), and/or electrical path(s) 206. The output analog signal(s) (real values) 214 from the simulated circuit(s), component(s), element(s), and/or electrical path(s) 206 may be converted to digital signals 216 by one or more analog-to-digital modules 208a, 208b. These digital signals 216, carrying encoded analog signals therein, may be transmitted to other modules within the digital simulation environment 200.

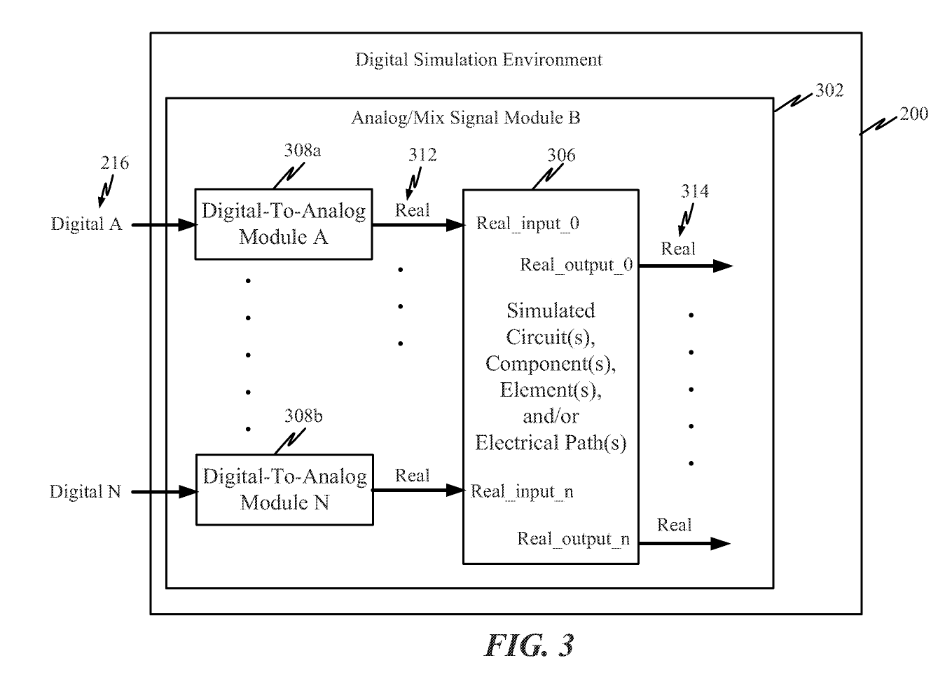

FIG. 3 is a block diagram illustrating another exemplary analog/mix signal module B 302 defined within a digital simulation environment 200 in which configurable bidirectional modules may be configured to convert multiple digital signals 216 to analog signals (real values) 312. For instance, the bidirectional modules may be configured as a plurality of digital-to-analog modules 308a, 308b that convert a plurality of digital signals 216 (e.g., output by analog/mix signal module A 202) into a plurality of analog signals or real values 312. These analog signals 312 may serve as inputs to another (second) simulated circuit(s), component(s), element(s), and/or electrical path(s) 306. This second simulated circuit(s), component(s), element(s), and/or electrical path(s) 306 may output an analog signal or real value 314 which may serve as an input to: (a) yet another analog/mix signal module and/or (b) another configurable bidirectional module that encodes the analog signal within a digital signal.

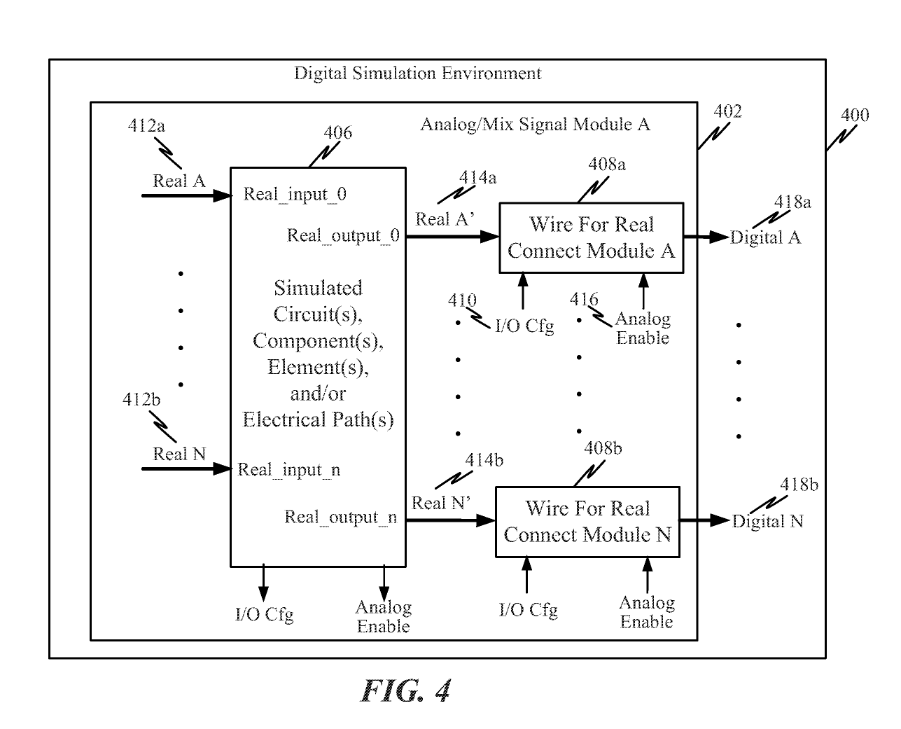

FIG. 4 is a block diagram illustrating another exemplary digital simulation environment in which a plurality of modules may be configured to encode analog signals within digital signals. An analog/mix signal module A 402 within the digital simulation environment 400 may include or define plurality of configurable and bidirectional modules 408a, and 408b (referred to as wire for real connection modules). The analog/mix signal module A 402 may receive, as input, one or more analog signals (real value) 412a, 412b and output one or more analog signals (real value) 414a, 414b.

Each wire for real connect module 408a and 408b may be configured to convert a real value or analog signal to a digital signal or representation (e.g., analog-to-digital) to be transmitted and subsequently converted back to the analog signal or real values (e.g., digital-to-analog). Whether the wire for real connect module 408a and 408b performs analog-to-digital conversion or digital-to-analog conversion may be based on an input/output configuration 410. Additionally, each wire for real connect module 408a and 408b may be configured, by an analog enable 416, to act as a pass-through element (i.e., digital-to-digital) or to provide an analog output (e.g., real/analog signal). In one example, the input/output configuration 410 and/or analog enable 416 may be provided, defined, and/or activated/enabled by the simulated circuit(s), component(s), element(s), and/or electrical path(s) 406 under test. Each wire for real connect module 408a and/or 408b may be individually configured independent of other modules.

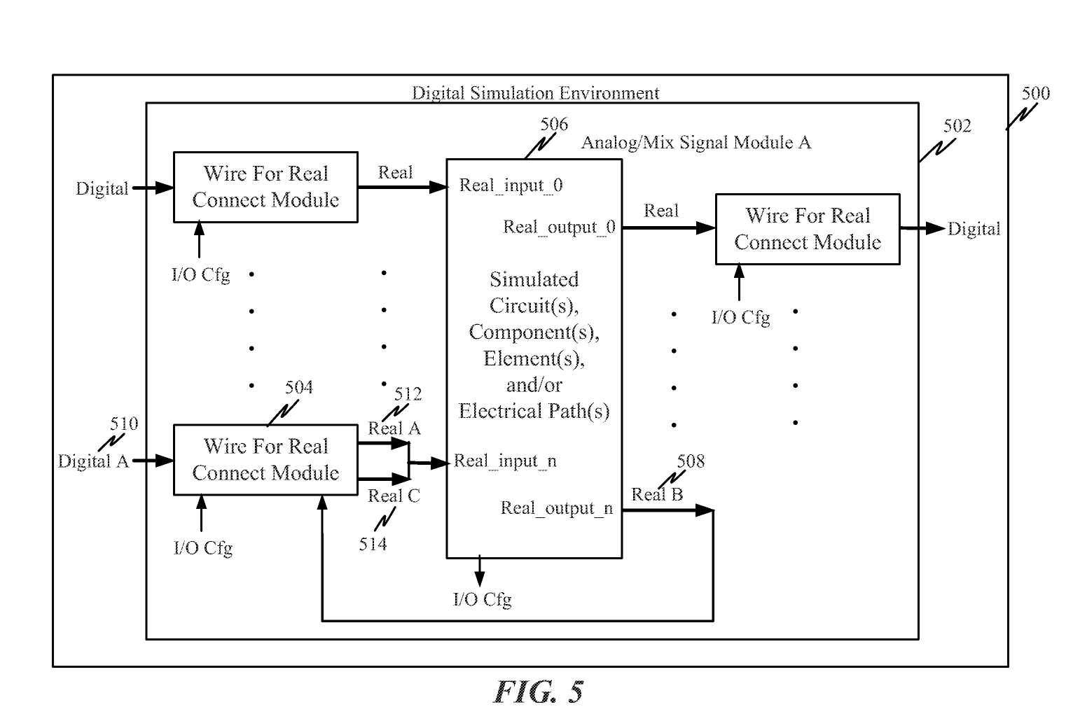

But for each real value to be transferred and restored, there are at least one source wire for real connect module (e.g., where an analog signal or real value is converted to a digital signal and transferred) and at least one destination wire for real connect module (e.g., where the digital signal is received and converted back to an analog signal or real value). The source wire for real connect module and the destination wire for real connect module typically exist in different analog/mixed signal modules. In the example of FIG. 4, the wire for real connect modules 408a, 408b may be a source connect module configured to convert an analog signal 414a, 414b to a digital signal 418a, 418b. Examples of destination connect modules 504 are illustrated in FIG. 5. FIG. 5 is a block diagram illustrating another exemplary digital simulation environment 500 in which a plurality of modules may be configured to convert between digital signals and analog signals (real values). In this example, an analog/mix signal module A 502 may include or define a wire for real connect module 504 may be configured to convert a digital signal 510 from digital-to-analog to provide a first analog/real signal A 512. Note that, in an alternative embodiment, the first analog/real signal A 512 may instead be obtained from (or generated by) an analog signal generator within the digital simulation environment 500. The first analog/real signal A512 may serve as an input to a simulated circuit(s), component(s), element(s), and/or electrical path(s) 506 under test. The simulated circuit(s), component(s), element(s), and/or electrical path(s) 506 may output a second analog/real signal B 508 which is fed back into the simulated circuit(s), component(s), element(s), and/or electrical path(s) 506. In one example, the wire for real connect module 504 may output the first analog/real signal A 512 and/or a third analog/real signal C 514 (where the third analog/real signal C 514 may be the second analog/real signal B 508), at different analog ports. In another example, the first analog/real signal A 512 and third analog/real signal C 514 may be merged by the wire for real connect module 504 to provide one output analog/real signal, for example, by outputting the sum of Real Signal A 512 and Real Signal C 514. Other operations like subtraction and/or multiplication of signals could be examples of “merging” of as well. In one example in which analog signals may be added, two or more current signals may be added together to obtain a combined output current signal.

Within the digital simulation environment 500, a node within the simulated circuit(s), component(s), element(s), and/or electrical path(s) 506 may be defined, for example, as a real value node that carries a real value or analog signal. When one physical analog node is to carry two or more real values or analog signals (e.g., where a signal's voltage and current may represent distinct signals), such physical analog node may be represented as two or more real value nodes within the simulation environment 500 and/or analog/mix signal module A 502. In one example, the digital representation of the analog node may be a 1-bit wide digital port, but it could carry multiple real value representations. In one example, merging and unmerging of the analog/real values may be performed outside the wire for real connect modules 504.

In an alternative example, either the input digital signal A 510 may include one or more encoded analog signals. For instance, the input digital signal A 510 may include or encode two analog signals that are output as analog signal A 512 and analog signal C 514.

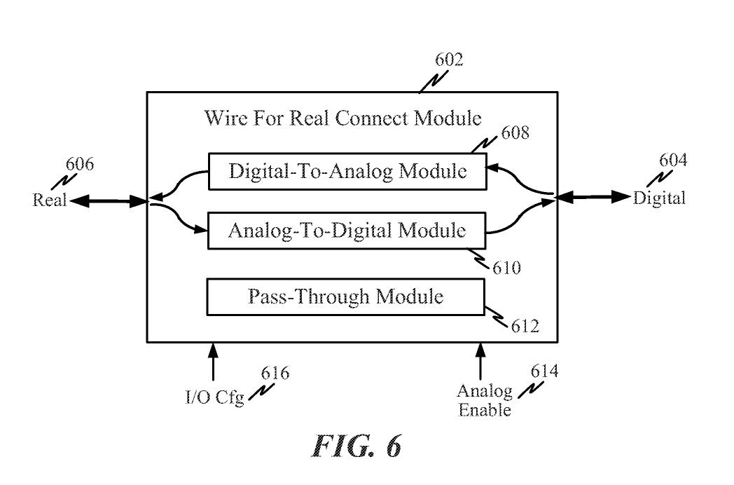

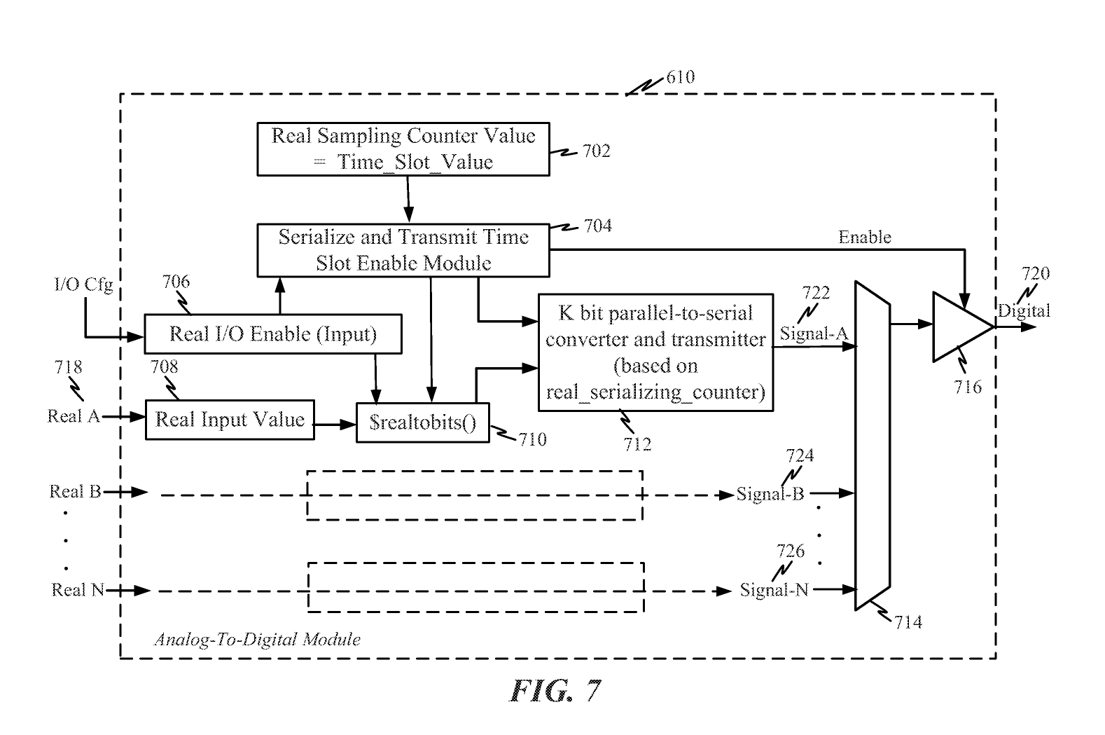

FIG. 6 is a block diagram illustrating an exemplary wire for real connect module 602 that is configurable and bidirectional and converts between digital signals and analog (real) signals within a digital simulation environment. The wire for real connect module 602 may include a digital-to-analog module 608 to convert a digital signal 604 to an analog (real) signal and an analog-to-digital module 610 to convert an analog (real) signal 604 to a digital signal. Additionally, the wire for real connect module 602 may include a pass-through module 612 which, when Analog Enable 614 is false or disabled, allows the module 612 to pass an input digital signal 604 through to an output, or equivalent one bit real value, 0 or 1. Additionally, the wire for real connect module 602 may be “bidirectional” in that it may be configured to convert from analog-to-digital (when digital port is used as output in some timeslots) or digital-to-analog (when digital port is used as input in other timeslots) based on an Input/Output configuration 616.

FIG. 7 is a block diagram illustrating an exemplary implementation of the analog-to-digital module 610 in FIG. 6. In this example, the analog-to-digital module 610 may use time division multiplexing to transmit the converted real/analog signal as a digital signal over a plurality of timeslots. To do this, a real sampling counter value 702 is used to define timeslots for a particular digital signal. A serialize and transmit time slot enable module 704 may serve to control serializing and synchronizing transmission of timeslotted digital signal.

A real input value module or interface 708 receives a real/analog signal (value) 718 and passes it to a real-to-bits conversion function 710 (within HDL). A real I/O enable module 706 serves to configure the wire for real connect module 602 as either analog-to-digital (e.g., in order to send or output an analog signal or real value) or digital-to-analog (e.g., in order to receive or input the analog signal or real value) depending on the real I/O enable module 706 configuration at each time slot. In this example, the module 602 has been configured as an analog-to digital module 610. The real I/O enable module 706 serves to configure the serialize and transmit module 704 and real-to-bits conversion function 710 for conversion and transmission of the digital signal on the selected timeslot(s). A parallel-to-serial converter and transmitter 712 converts the parallel bits from the real-to-bits conversion function 710 and serializes them for output via a first output driver 716 as a digital signal 720.

Note that, a multiplexer 714 may be used to allow multiple signals to be transmitted over different timeslots. For instance, a first digital signal A 722 may be transmitted over a first set of defined timeslots, a second digital signal B 724 may be transmitted over a second set of defined timeslots, and a third digital signal N 726 may be transmitted over a third set of defined timeslots. That is, the first digital signal A 722, second digital signal B 724, and third digital signal N 726 are transmitted in different timeslots of the output digital signal 720. In some examples, the real/analog signal 718 may include multiple components (e.g., voltage and current at the same analog node) and all component real values may be converted into multiple digital signals transmitted over different timeslots.

In other examples, a plurality of real/analog signal inputs may serve to generate a plurality of digital signals 722, 724, and/or 726 which are transmitted over different timeslots.

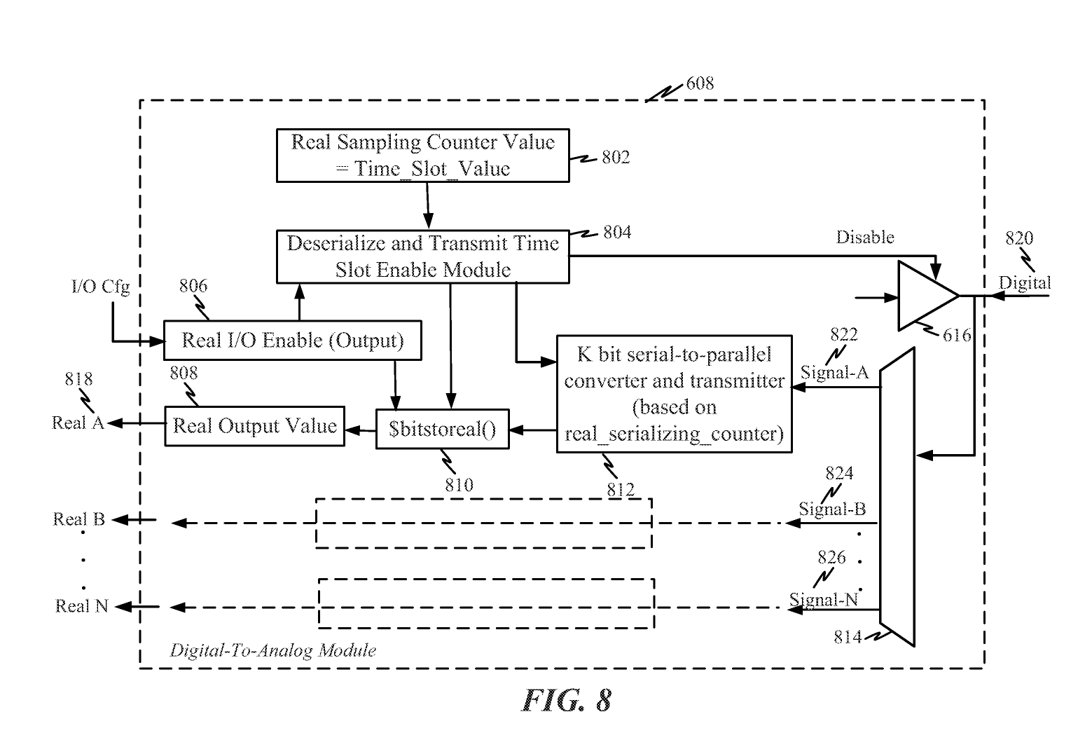

FIG. 8 is a block diagram illustrating an exemplary implementation of the digital-to-analog module 608 in FIG. 6. In this example, the digital-to-analog module 608 may use time division multiplexing to receive a plurality of digital signals over a plurality of timeslots and generate one or more real/analog signals. To do this, a real sampling counter value 802 is used to define timeslots for a particular digital signal. A deserialize and transmit time slot enable module 804 may serve to control deserializing and synchronizing reception of timeslotted digital signals.

A multiplexer 814 may be used to allow multiple signals to be received over different timeslots of an input digital signal 820. For instance, a first digital signal A 822 may be transmitted over a first set of defined timeslots, a second digital signal B 824 may be transmitted over a second set of defined timeslots, and a third digital signal N 826 may be transmitted over a third set of defined timeslots. That is, the first digital signal A 822, second digital signal B 824, and third digital signal N 826 are received in different timeslots of the input digital signal 820.

A serial-to-parallel converter and transmitter 812 converts the serial bits in a received digital signal 822 into parallel bits sent to a bits-to-real conversion function 810. The bits-to-real conversion function 810 converts the digital input signal/representation back to an analog/real output 808 which makes-up the real/analog output signal 818. A real I/O enable module 806 serves to configure the wire for real connect module 602 at each time slot as either analog-to-digital or digital-to-analog depending on the real I/O enable module 806 configuration. In this example, the module 602 has been configured as a digital-to-analog module 608. The real I/O enable module 806 serves to configure the deserialize and transmit time slot enable module 804 and bits-to-real conversion function 810 for reception and conversion of the digital signal on the selected timeslot(s).

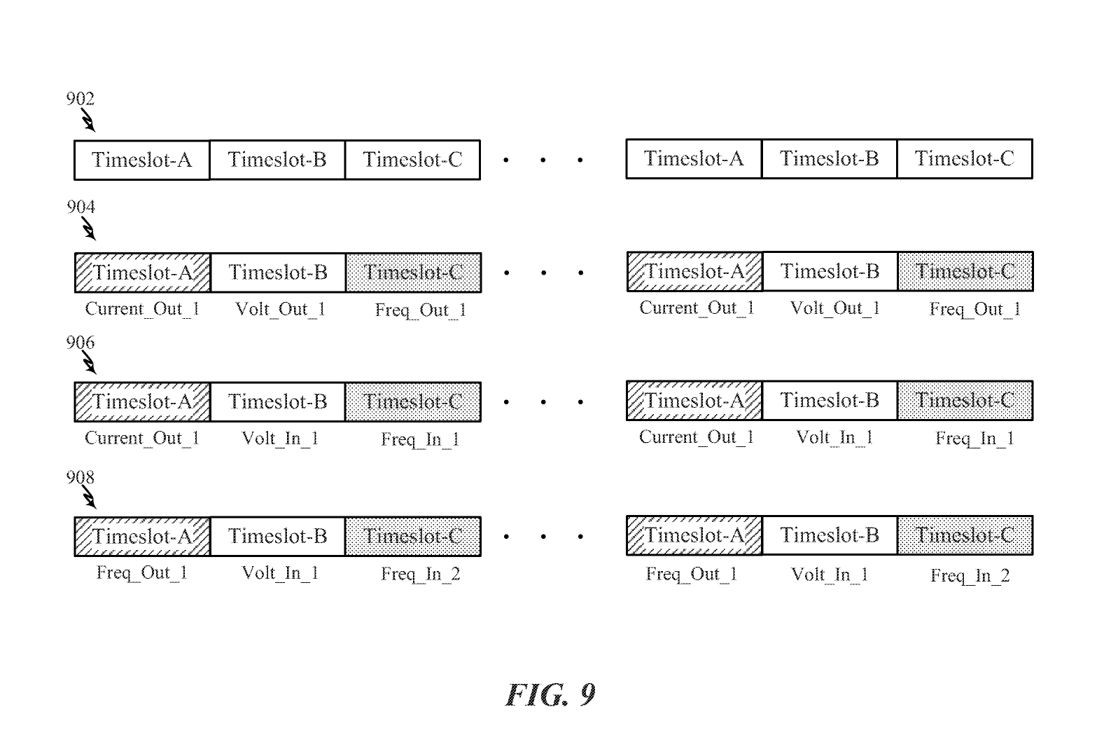

FIG. 9 is a block diagram illustrating various time division multiplexing schemes that may be used by a configurable, bidirectional wire for real connect module. Generally, a digital output and/or input (e.g., inout as defined in general HDL) of a wire for real connect module may be configured to transmit and/or receive digital signals within a plurality of timeslots 902. The timeslot windows allocated to a particular signal may repeat every x timeslot windows if there are a total of x real values to be transferred in both directions combined. Each timeslot window may include k timeslots to transfer K bits of digital values if one real value is represented with a K bit digital value.

The digital signals in each timeslot may correspond to analog/real signals. For instance, the digital signals carried by a first subset of the timeslots may correspond to a first analog/real signal while digital signals carried by a second subset of the timeslots may correspond to a second analog/real signal.

In one example, the timeslots 904 may be allocated to digitally transfer a plurality of distinct types of analog/real signals, such as current output signals, voltage output signals, and/or frequency output signals.

In another example, the timeslots 906 may be allocated to both input and output signals. For instance, some timeslots may allocated to input signals while other timeslots may be allocated to output signals. Consequently, each timeslot may be defined (e.g., by the real I/O enable module 706 & 806) as either an input signal or an output signal independent of other timeslots.

In yet another example, the timeslots 908 may be allocated to multiple signals of the same type (e.g., voltage, current, or frequency) or signals of different types.

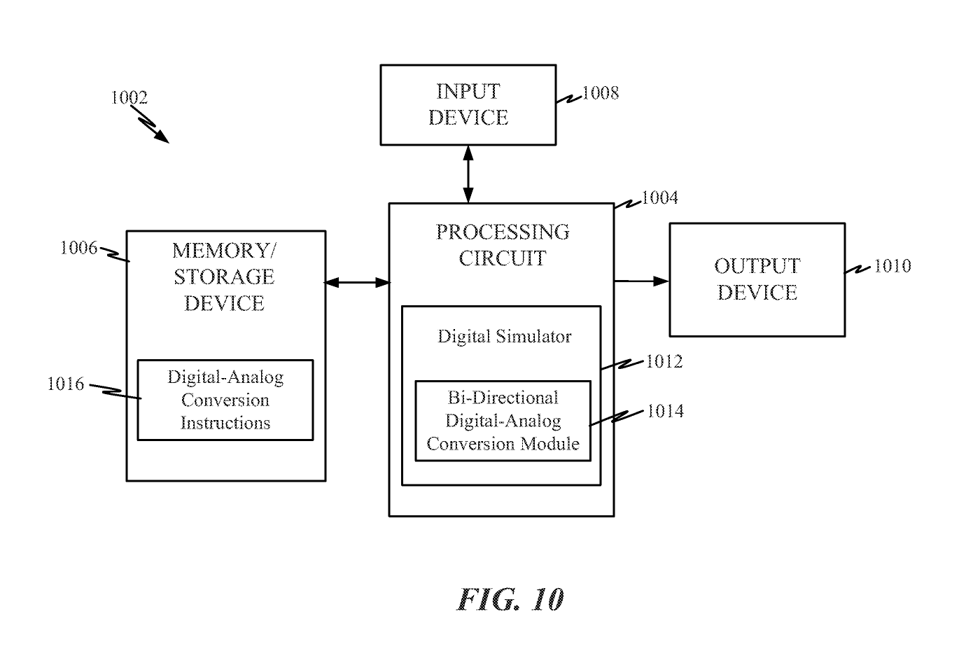

FIG. 10 is a block diagram illustrating a device that implements a digital simulator in which one or more aspects for converting and transferring analog/real signals through digital ports may be implemented. The device 1002 may include a processing circuit 1004 (e.g., processing unit, etc.) coupled to a memory/storage device 1006, an input device 1008 (e.g., keyboard, etc. and an output device 1010 (e.g., display monitor, etc.). The processing circuit 1004 may be adapted to execute an event-driven digital simulator 1012 that may serve to simulate the characteristics and response of circuit(s), electrical/electronic components or elements, and/or electrical paths/interfaces. In one example, the digital simulator 1012 may include a bidirectional digital-analog conversion module 1014 in which signals may be converted between digital and analog representations. For instance, the bidirectional digital-analog conversion module 1014 may operate to perform one or more of the features illustrated in FIGS. 1-9 and 11-12. The memory/storage device 1006 may include digital-analog conversion instructions 1016 that, when executed by the processing circuit 1004, perform on or more of the functions of the bidirectional digital-analog conversion module 1014.

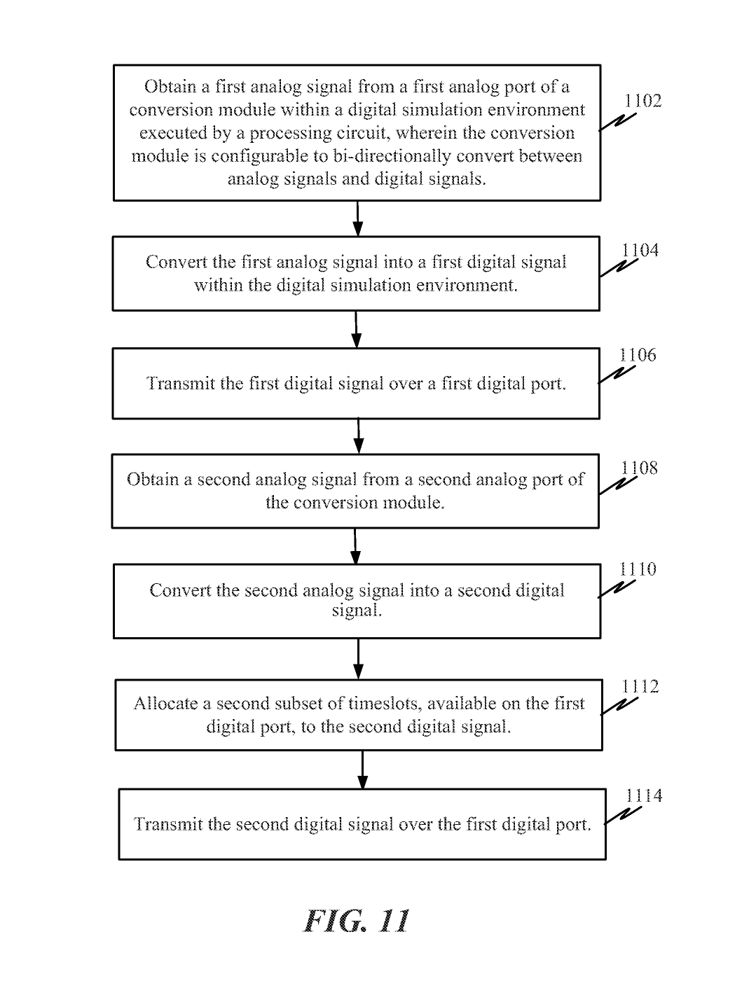

FIG. 11 is a block diagram illustrating a method that may be performed to implement a bidirectional digital-analog conversion module within a digital simulator. According to one aspect, the bidirectional digital-analog conversion module may be adapted to transfer analog signal values (e.g., real values) through a digital connection (or port) within a digital simulator executed by a processing circuit, where the digital connection is also a representation of a physical analog connection (or port). This conversion may be done, for example, only with code native to the digital simulator (e.g., without external calls or non-native instructions to the digital simulator).

A first analog signal may be obtained from a first analog port of a conversion module within a digital simulation environment executed by a processing circuit, wherein the conversion module is configurable to bi-directionally convert between digital signals and analog signals 1102. For example, an analog signal may be a real number while a digital signal may be a binary number.

Another aspect provides for the conversion module including one or more analog ports and at least one digital port, where the digital port may use time division multiplexing to carry a plurality of analog signals values in different timeslots. For example, an analog signal or real number generator within the digital simulation environment may generate the first analog signal. The first digital signal may be transmitted over a first subset of timeslots, available on the first digital port, allocated to the first digital signal. The first analog signal may be converted into a first digital signal within the digital simulation environment 1104. The first digital signal may then be transmitted over a first digital port 1106. For instance, the first analog signal may then be used by the digital simulator to characterize simulated electrical circuits, components, elements, and/or paths/interfaces.

Yet another aspect provides for the conversion module including a plurality of bi-directional input/output channels over a single digital port, such that some of the timeslots over the digital port may be associated with a first input signal while other timeslots may be associated with a second output signal. For instance, in one implementation, the first digital port of the conversion module may be dynamically configurable to allocate timeslots for input or output signals, where the designation of a timeslot for input signals is independent of the designation of other timeslots for either input or output signals. For instance, a second subset of timeslots on the first digital port may be defined for transmissions of a second digital signal while the first subset of timeslots is concurrently used to transmit the first digital signal. Additionally, the conversion module may be configurable to operate in a first mode of operation in which it converts an analog signal to a digital signal and operate in a second mode of operation in which it converts a digital signal to an analog signal.

In some implementations, the conversion of the first analog signal into the first digital signal may be performed solely in native hardware description language instructions.

A second analog signal may be obtained from a second analog port of the conversion module 1108. The second analog signal may be converted into a second digital signal 1110. A second subset of timeslots, available on the first digital port, may be allocated to the second digital signal 1112. The second digital signal may be transmitted over the first digital port 1114.

In one example, the first digital port may be further defined by a second subset of timeslots for a second digital signal, and a third subset of timeslots for a third digital signal. In one instance, the first digital signal may correspond to a voltage signal, the second digital signal may correspond to a current signal, and the third digital signal may correspond to a frequency signal. The first digital signal, the second digital signal, and the third digital signal may be combined to define the first analog signal. That is, the first, second, and third digital signals may be components of, or serve to characterize, the first analog signal. In other examples, the first, second, and third digital signals may each represent a distinct analog signals or real values.

Another aspect provides for the conversion module to dynamically configure its input and output ports while the digital simulator is running. For instance, the first digital port and first analog port of the conversion module may be dynamically configurable as input and/or output ports. That is, the ports of the conversion module may be configured after the digital simulator has started execution. In one example, the first digital port of the conversion module is dynamically configurable to allocate timeslots to different digital signals.

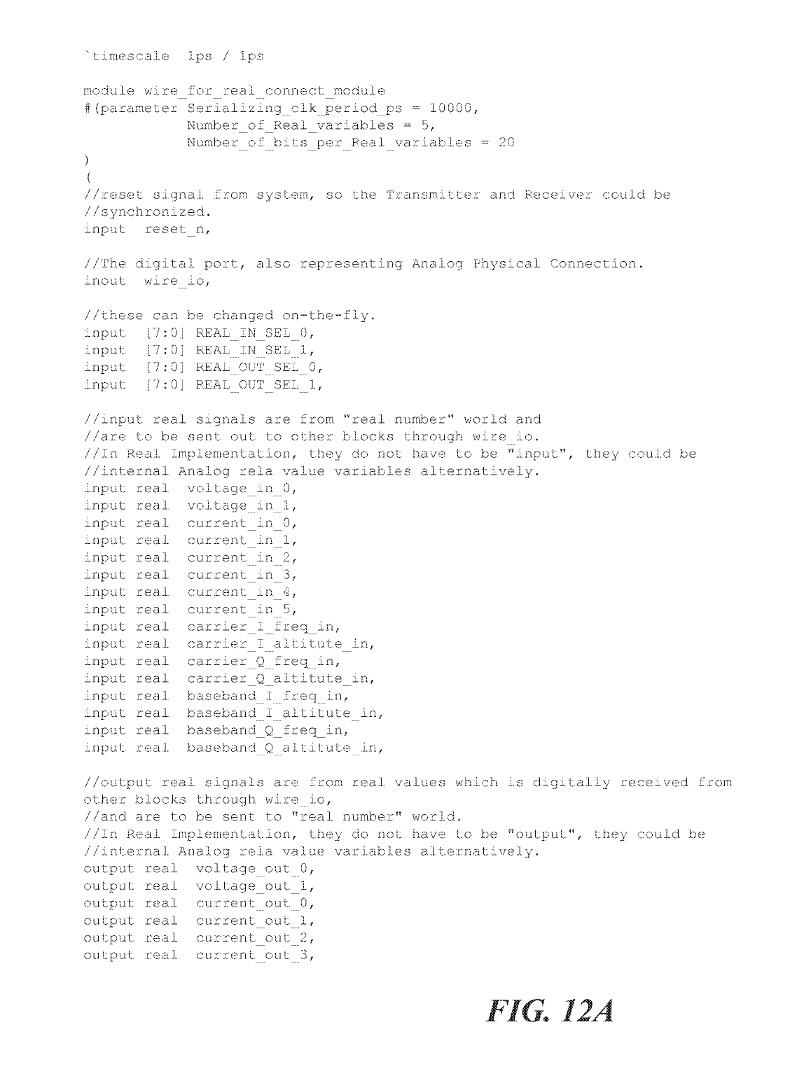

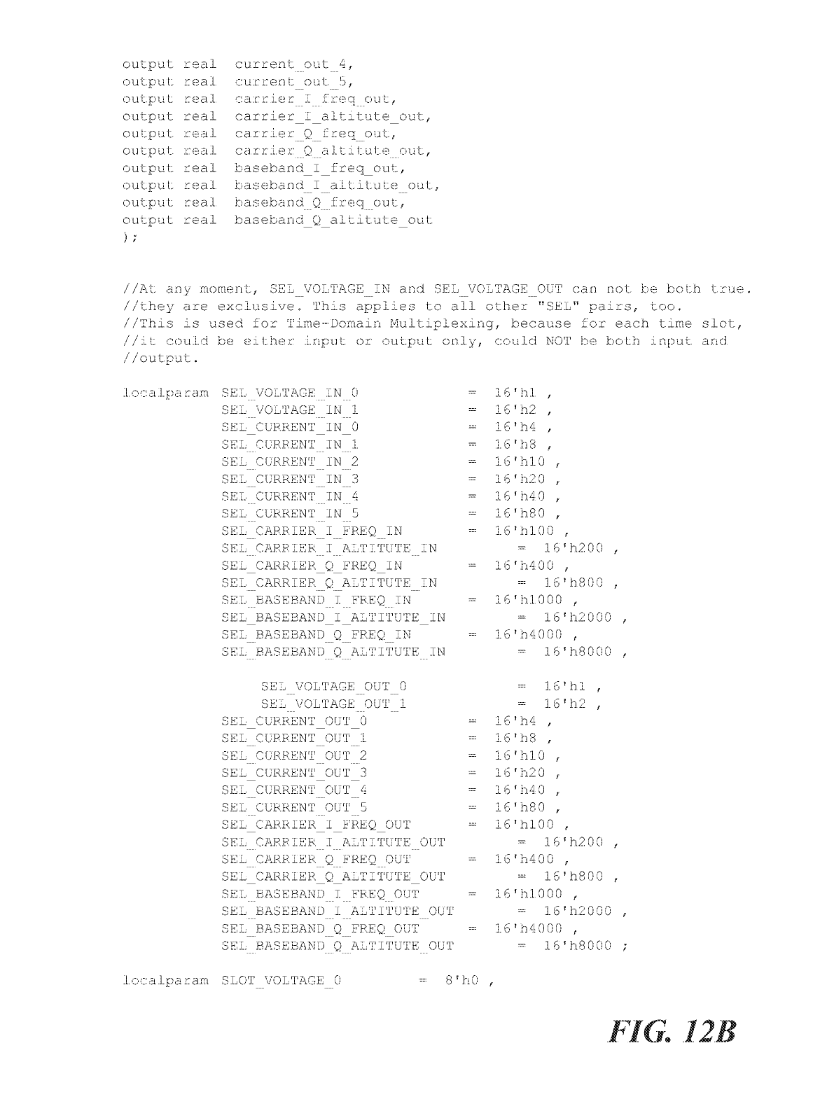

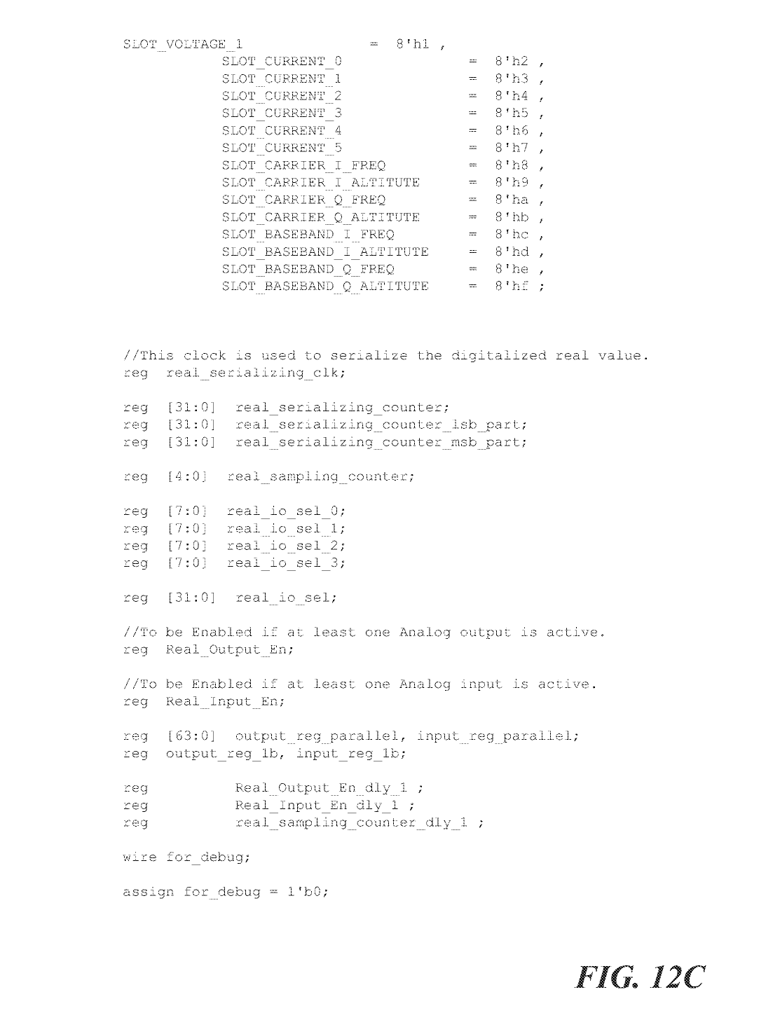

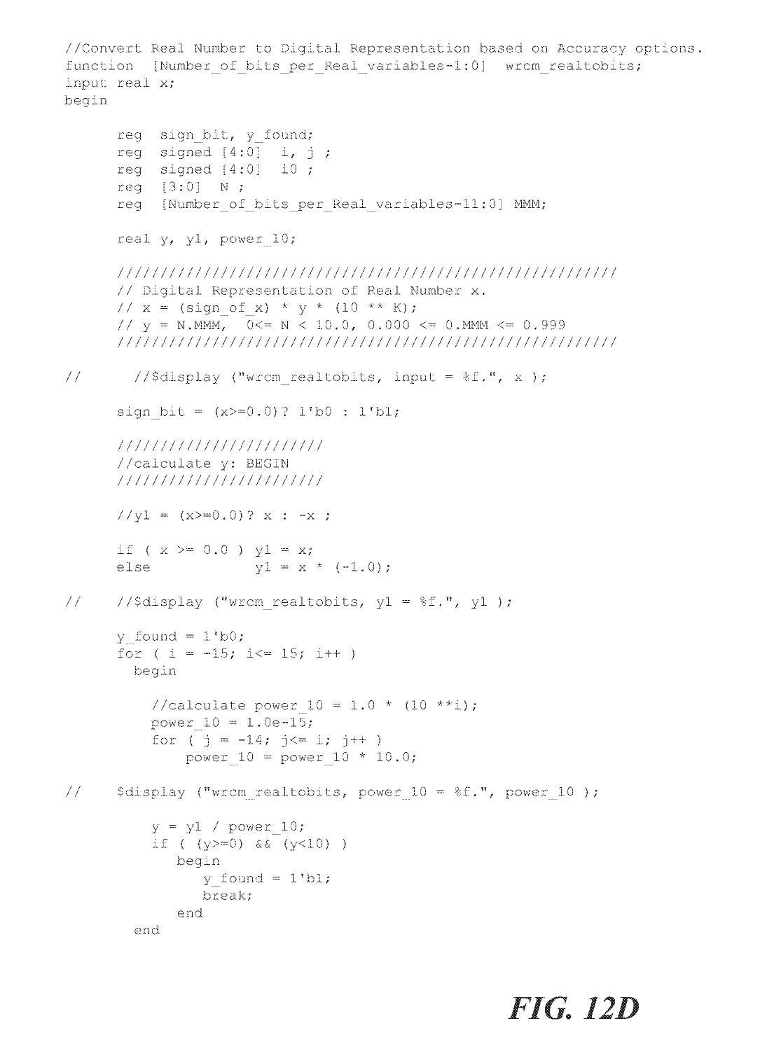

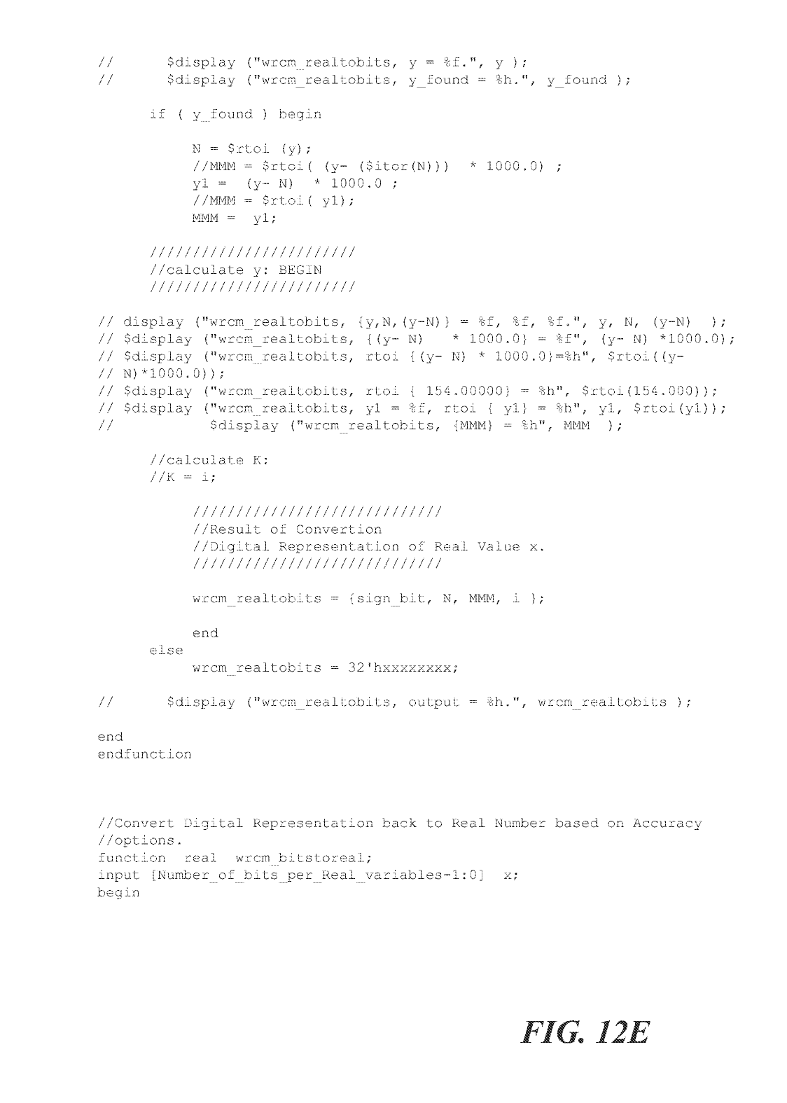

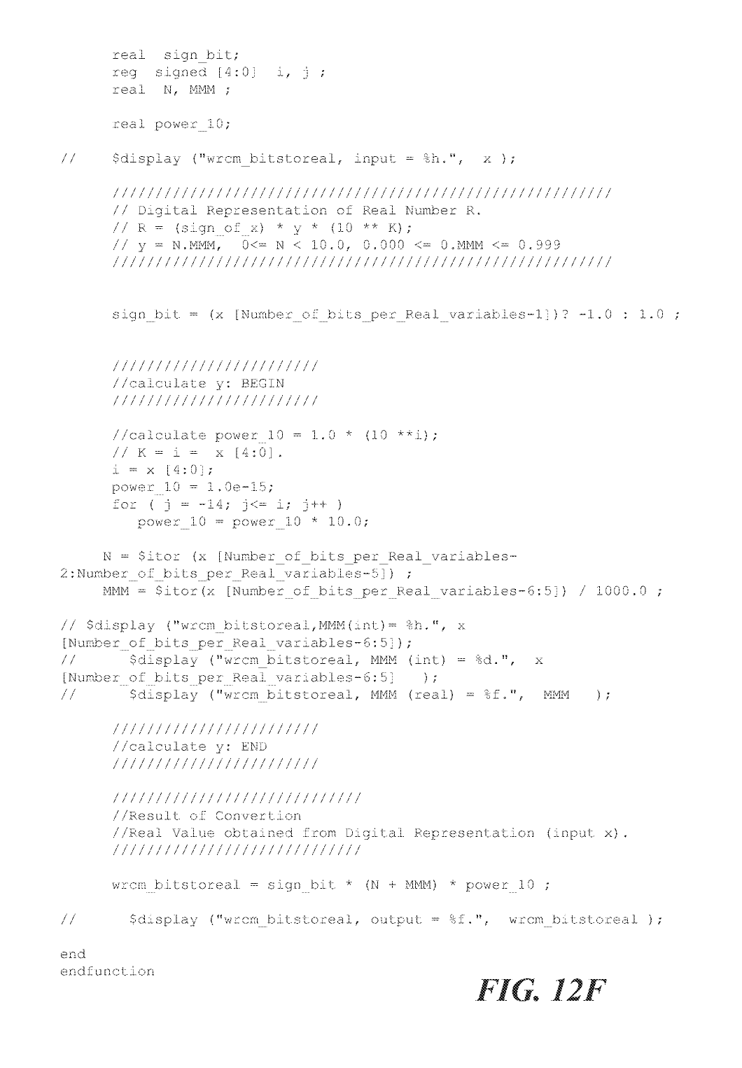

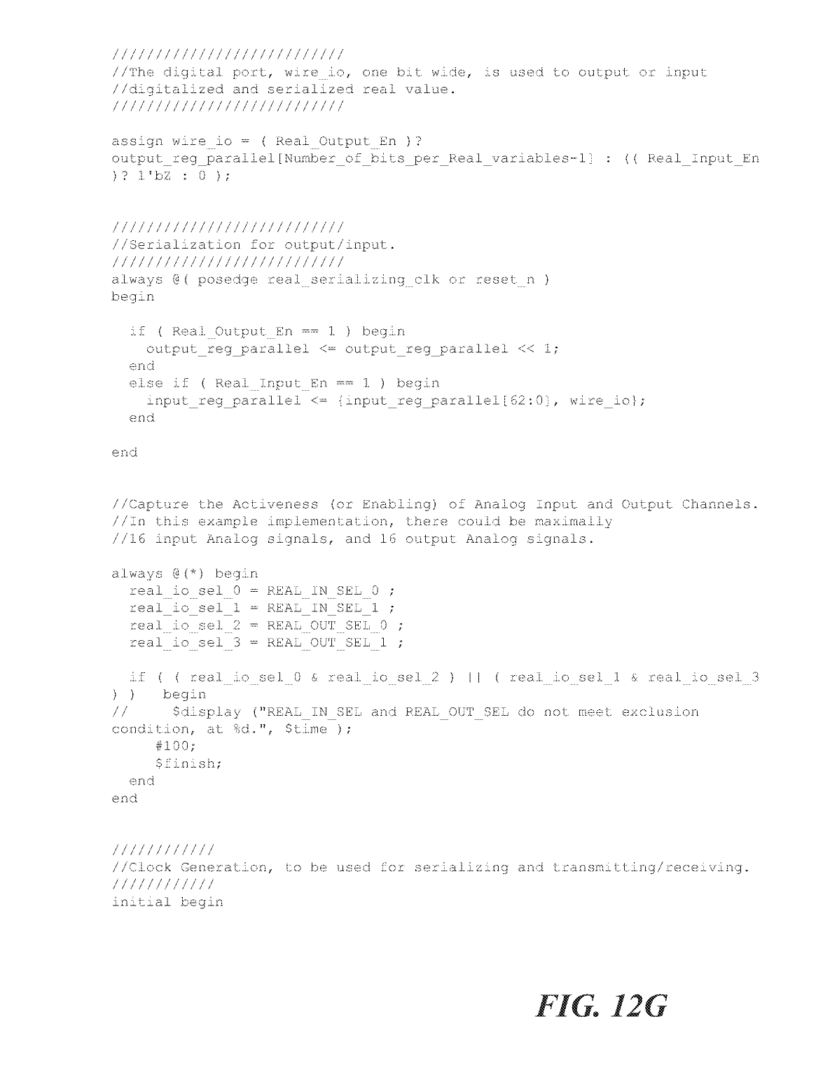

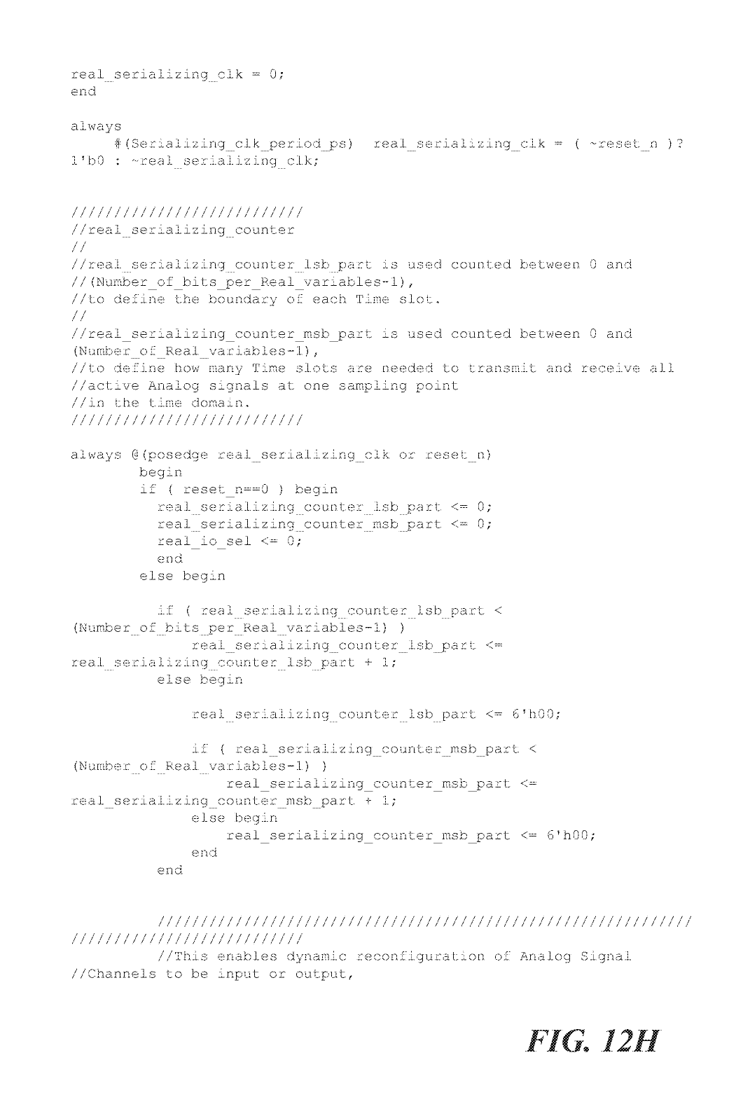

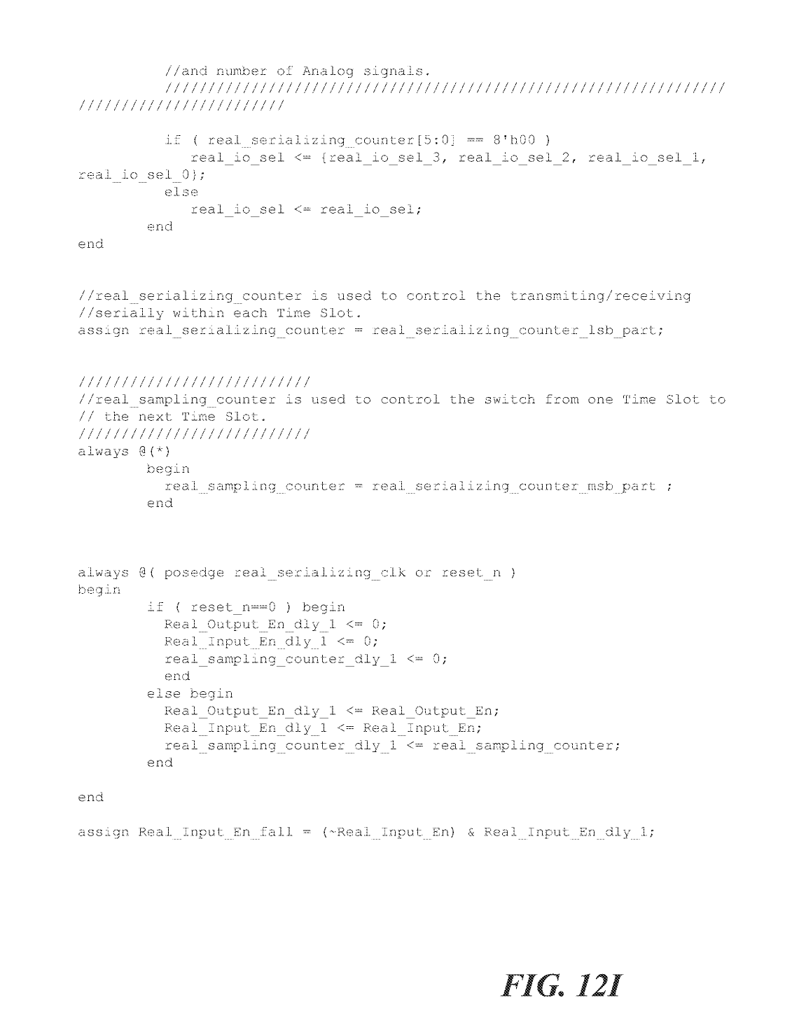

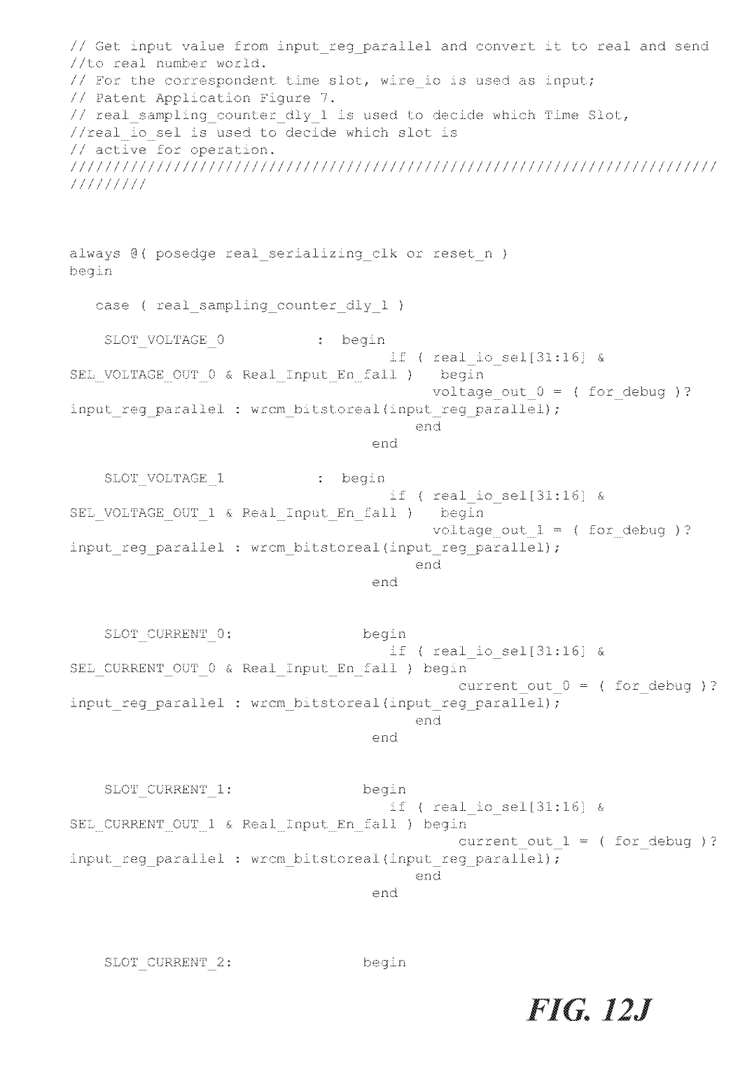

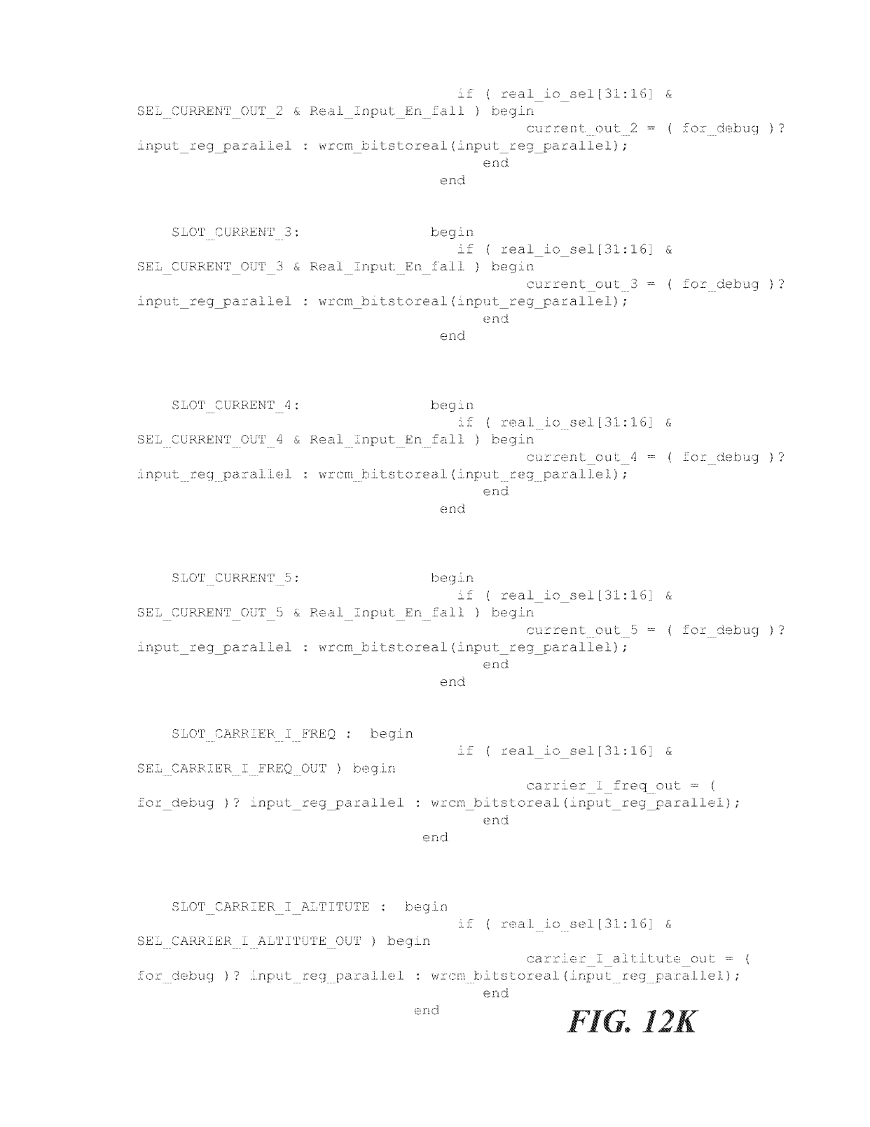

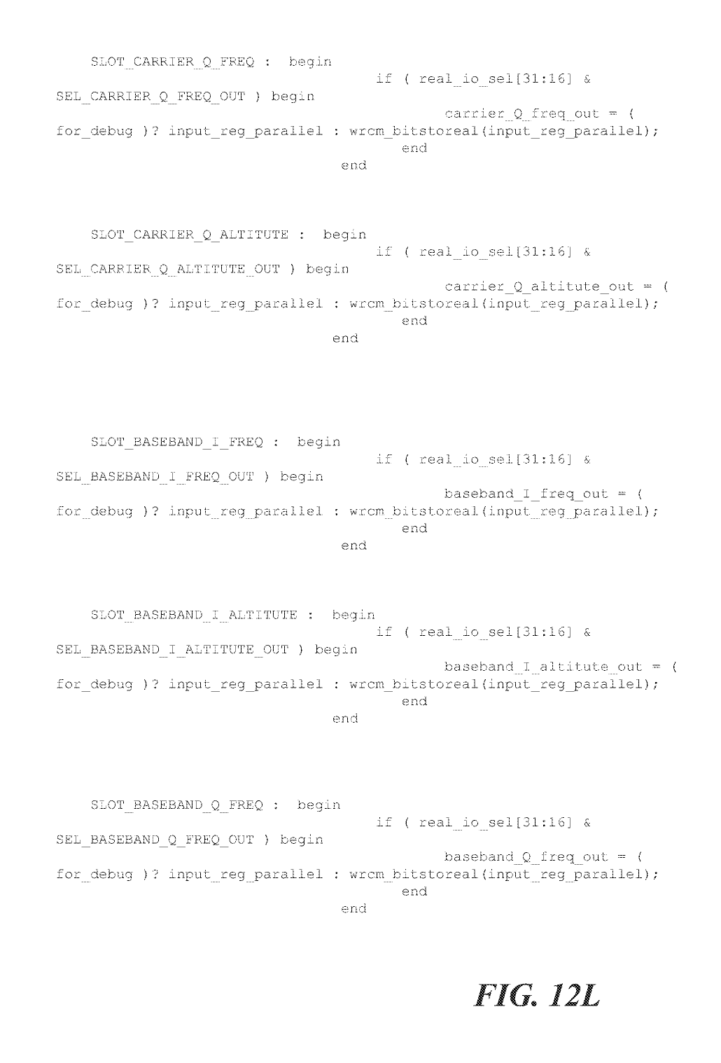

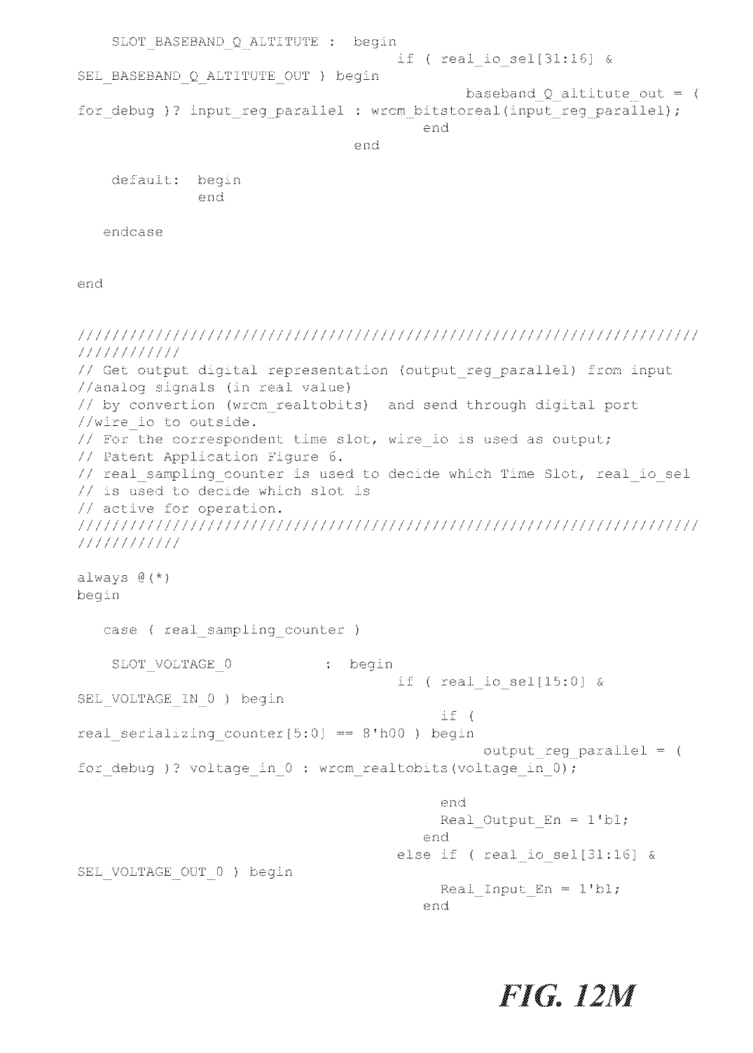

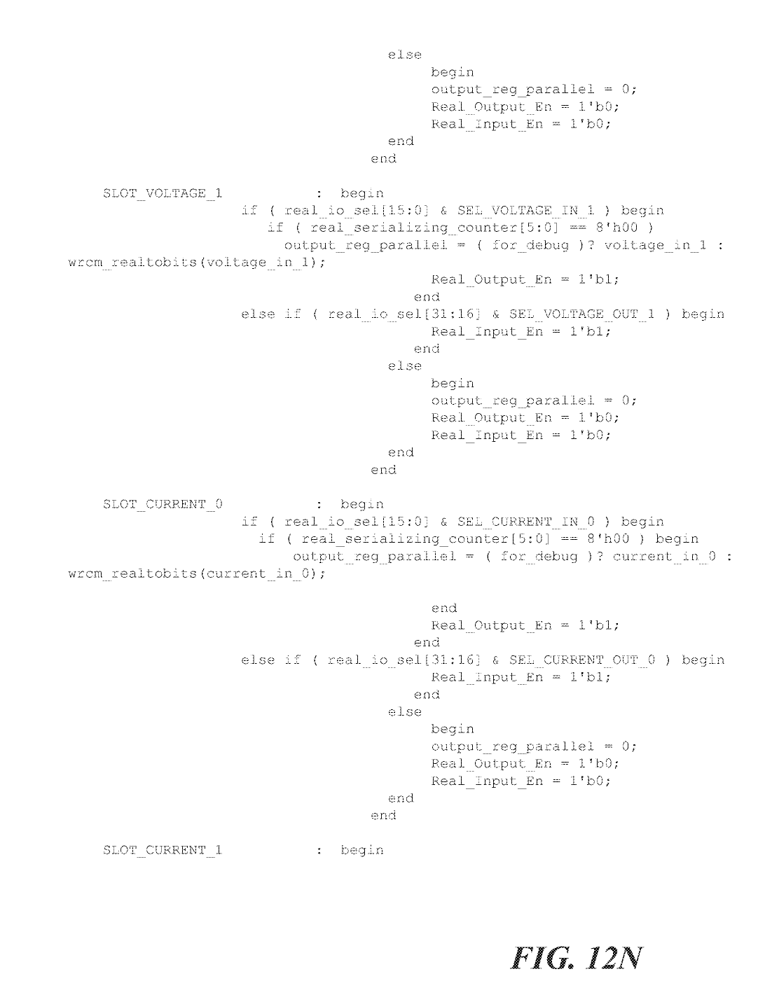

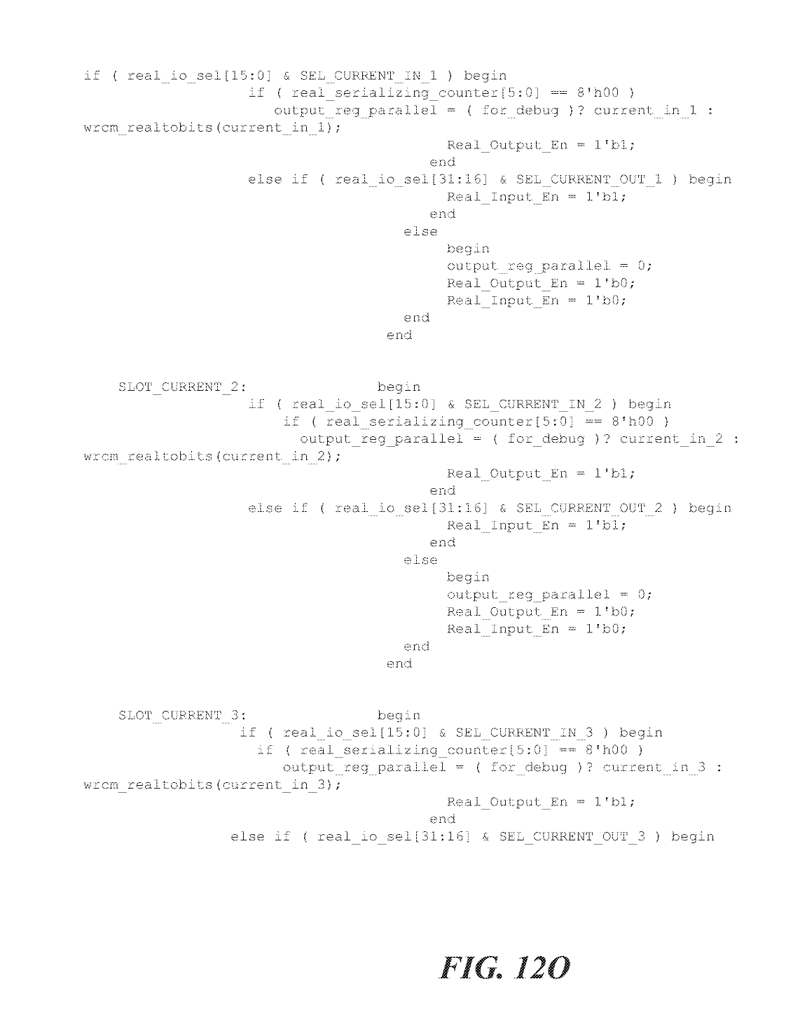

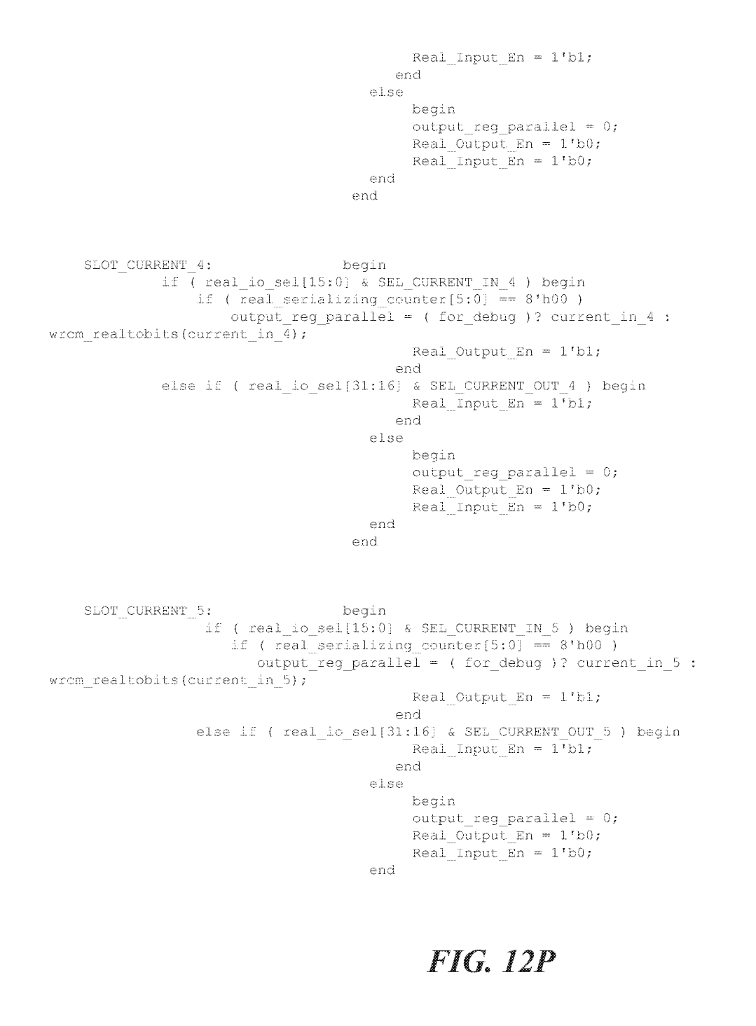

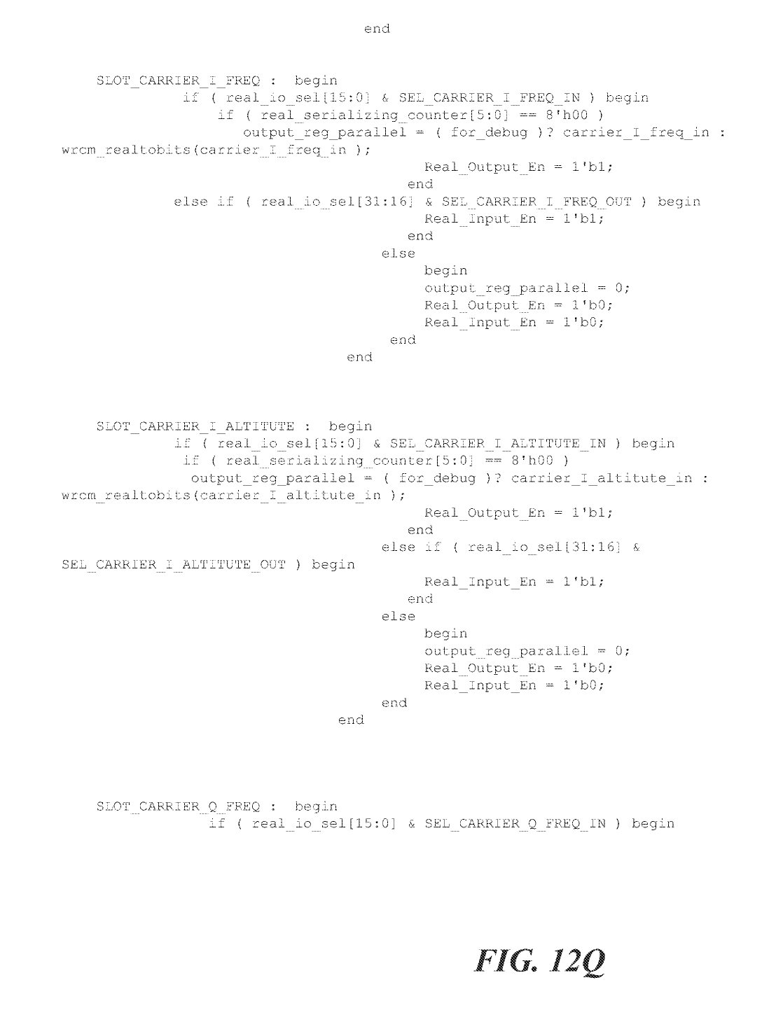

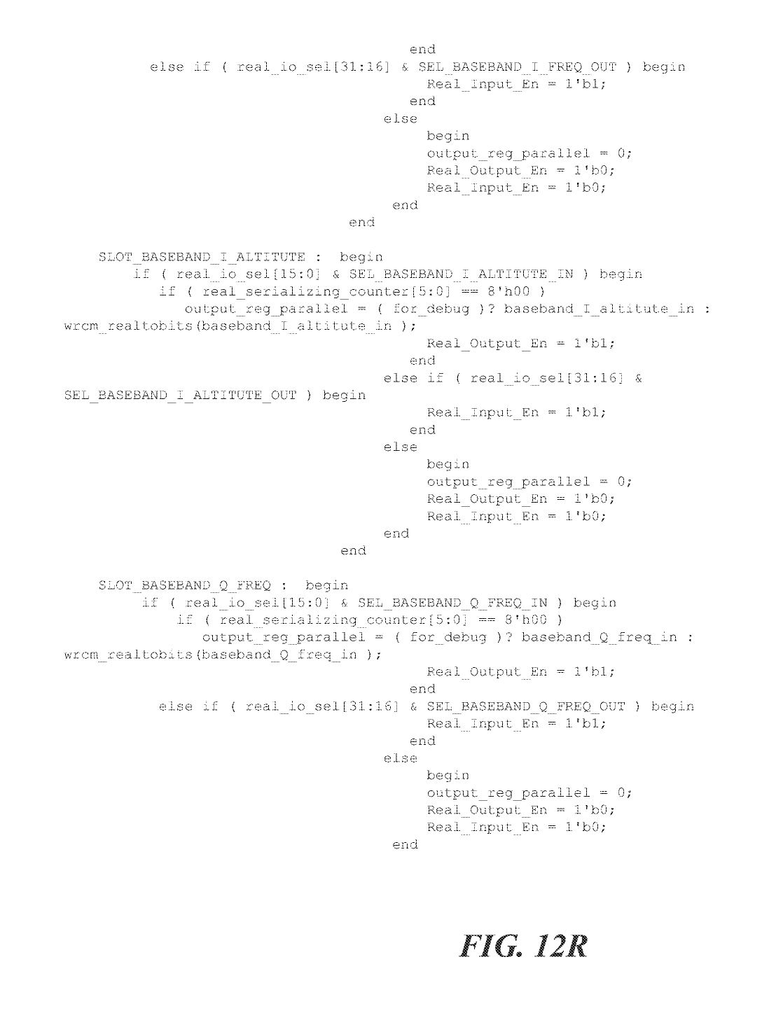

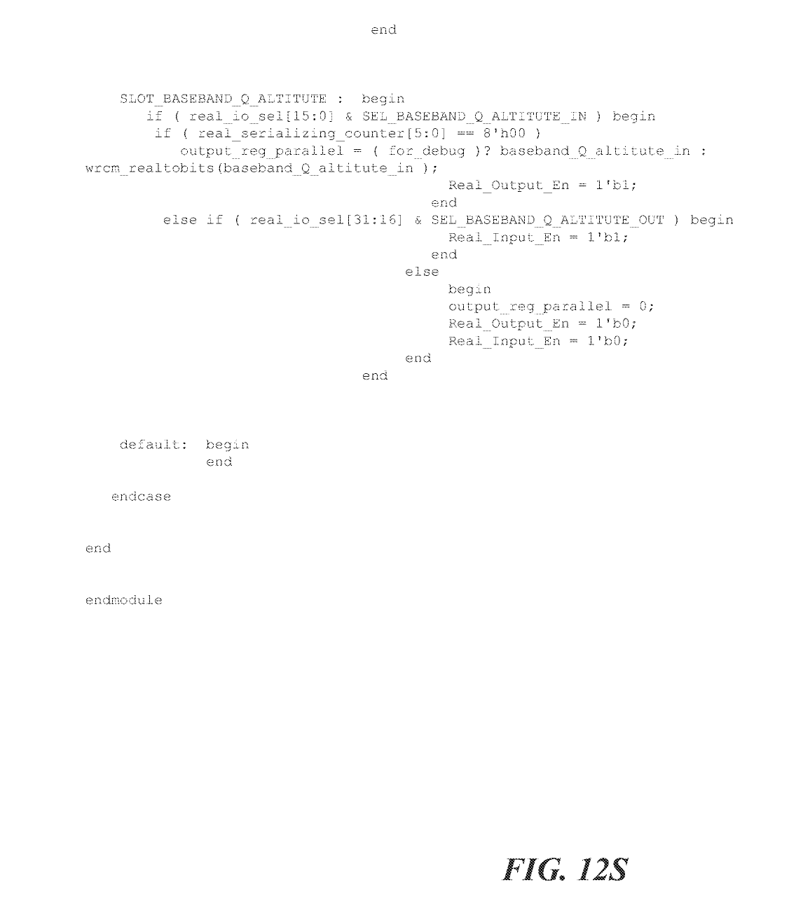

FIG. 12 (comprising FIGS. 12A-12S) illustrates exemplary code/instructions for a digital-analog conversion module in a hardware description language. This exemplary code includes modules corresponding to the various modules illustrated in FIGS. 7 & 8.

FIG. 12A-C define input and output parameters, variables, and registers for a wire_for_real_connect_module.

FIG. 12D-E illustrates an exemplary wrcm_realtobits function that may be performed or executed by the real-to-bits conversion function 710 (FIG. 7), which may support a user-definable number of digital bits for representing one analog/real value.

FIG. 12E-12F illustrates an exemplary wrcm_bitstoreal function that may be performed or executed by the bits-to-real conversion function 810 (FIG. 8). conversion function 810 (FIG. 8), which may support a user-definable number of digital bits for representing one analog/real value.

FIG. 12G illustrates the definition of an exemplary digital port (wire_io) function, a serial-to-parallel function, and a parallel-to-serial function.

FIG. 12G-H illustrates an exemplary clock generator function. Clocks with the same frequency may be present/available at both a source wire-to-real connect module and a destination wire-to-real connect module to ensure synchronization when transmitting and receiving data through a digital port.

FIG. 12H-I illustrates an exemplary real_serializing_counter and real_sampling_{—} counter that may be performed or executed to obtain the real sampling counter values 702 (FIG. 7) and 802 (FIG. 8).

FIG. 12J-M illustrates an exemplary code or instructions that may be executed by the deserialize and transmit time slot enable module 804 (FIG. 8) to receive serial data, perform serial-to-parallel conversion and decode the parallel data to real value and/or recover and output the real value signal.

FIG. 12M-S illustrates code or instructions that may be executed by the serialize and transmit time slot enable module 704 (FIG. 7) to encode a real value (e.g., analog signal) into a digital representation (e.g., digital signal), assign the digital representation to parallel data registers, serialize and output the digital signal at wire_io digital port based on time slot allocation.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable storage medium. The computer-readable storage medium may be a non-transitory computer-readable storage medium. A non-transitory computer-readable storage medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable storage medium may also include, by way of example, a carrier wave, a transmission line, and any other suitable medium for transmitting software and/or instructions that may be accessed and read by a computer. The computer-readable storage medium may be embodied in a computer program product.

Moreover, a storage medium may represent one or more devices for storing data, including read-only memory (ROM), random access memory (RAM), magnetic disk storage mediums, optical storage mediums, flash memory devices and/or other machine-readable mediums and, processor-readable mediums, and/or computer-readable mediums for storing information. The terms “machine-readable medium”, “computer-readable medium”, and/or “processor-readable medium” may include, but are not limited to non-transitory mediums such as portable or fixed storage devices, optical storage devices, and various other mediums capable of storing, containing or carrying instruction(s) and/or data. Thus, the various methods described herein may be fully or partially implemented by instructions and/or data that may be stored in a “machine-readable medium”, “computer-readable medium”, and/or “processor-readable medium” and executed by one or more processors, machines, and/or devices.

One or more of the components, steps, features, and/or functions illustrated in the Figures may be rearranged and/or combined into a single component, step, feature, or function or embodied in several components, steps, or functions. Additional elements, components, steps, and/or functions may also be added without departing from novel features disclosed herein. The apparatus, devices, and/or components illustrated in the Figures may be configured to perform one or more of the methods, features, or steps described in the Figures. The novel algorithms described herein may also be efficiently implemented in software and/or embedded in hardware.

In addition, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, or any combination thereof. When implemented in software, firmware, middleware, or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features of the invention described herein can be implemented in different systems without departing from the invention. It should be noted that the foregoing embodiments are merely examples and are not to be construed as limiting the invention. The description of the embodiments is intended to be illustrative, and not to limit the scope of the claims. As such, the present teachings can be readily applied to other types of apparatuses and many alternatives, modifications, and variations will be apparent to those skilled in the art.

What is claimed is:

1. A method for converting signals within a digital simulation environment, comprising:
obtaining a first analog signal via a first analog port of a conversion module within a digital simulation environment executed by a processing circuit, wherein the conversion module is configurable to bi-directionally convert between digital signals and analog signals;
converting the first analog signal into a first digital signal within the digital simulation environment; and
transmitting the first digital signal over a first digital port.

2. The method of claim 1, wherein the analog signal is a real number.

3. The method of claim 1, wherein conversion of the first analog signal into the first digital signal is performed solely in native hardware description language instructions within the digital simulation environment.

4. The method of claim 1, wherein the conversion module is configurable to operate in a first mode of operation in which it converts an analog signal to a digital signal and operate in a second mode of operation in which it converts a digital signal to an analog signal.

5. The method of claim 1, wherein the first digital signal is transmitted over a first subset of timeslots, available on the first digital port, allocated to the first digital signal.

6. The method of claim 5, wherein a second subset of timeslots on the first digital port are defined for transmissions of a second digital signal while the first subset of timeslots is concurrently used to transmit the first digital signal.

7. The method of claim 6, wherein the first subset of timeslots are utilized for the outgoing first digital signal and the second subset of timeslots is used for an incoming second digital signal.

8. The method of claim 5, further comprising:
obtaining a second analog signal from a second analog port of the conversion module;
converting the second analog signal into a second digital signal;
allocating a second subset of timeslots, available on the first digital port, to the second digital signal; and
transmitting the second digital signal over the first digital port.

9. The method of claim 5, wherein the first digital port is further defined by a second subset of timeslots for a second digital signal, and a third subset of timeslots for a third digital signal.

10. The method of claim 9, wherein the first digital signal corresponds to a voltage signal, the second digital signal corresponds to a current signal, and the third digital signal corresponds to a frequency signal.

11. The method of claim 10, wherein the first digital signal, the second digital signal, and the third digital signal are multiple components and/or characteristics of the first analog signal.

12. The method of claim 1, wherein the first digital port and first analog port of the conversion module are dynamically configurable as input or output ports.

13. The method of claim 1, wherein the first digital port of the conversion module is dynamically configurable to allocate timeslots to different digital signals.

14. The method of claim 1, wherein the first digital port of the conversion module is dynamically configurable to allocate timeslots for input or output signals, where the designation of a timeslot for input signals is independent of the designation of other timeslots for either input or output signals.

15. A processor-readable non-transitory medium comprising instructions operational within a digital simulation environment, which when executed by a processing circuit causes the processing circuit to:
obtain a first analog signal via a first analog port of a conversion module within a digital simulation environment executed by a processing circuit, wherein the conversion module is configurable to bi-directionally convert between digital signals and analog signals;
convert the first analog signal into a first digital signal within the digital simulation environment; and
transmit the first digital signal over a first digital port.

16. The processor-readable non-transitory medium of claim 15, wherein conversion of the first analog signal into the first digital signal is performed solely in native hardware description language instructions within the digital simulation environment.

17. The processor-readable non-transitory medium of claim 15, wherein the conversion module is configurable to operate in a first mode of operation in which it converts an analog signal to a digital signal and operate in a second mode of operation in which it converts a digital signal to an analog signal.

18. The processor-readable non-transitory medium of claim 15, wherein the first digital signal is transmitted over a first subset of timeslots, available on the first digital port, allocated to the first digital signal.

19. The processor-readable non-transitory medium of claim 16, wherein a second subset of timeslots on the first digital port are defined for transmissions of a second digital signal while the first subset of timeslots is concurrently used to transmit the first digital signal.

20. The processor-readable non-transitory medium of claim 18, further comprising instruction, which when executed by the processing circuit, causes the processing circuit to:
obtain a second analog signal from a second analog port of the conversion module;
convert the second analog signal into a second digital signal;
allocate a second subset of timeslots, available on the first digital port, to the second digital signal; and
transmit the second digital signal over the first digital port.
